(19) United States
(12) Patent Application Publication
(10) Pub. No.: US 2014/0102634 A1
(43) Pub. Date: Apr. 17, 2014

(54) Method of Manufacturing Spa/tub Shell with Improved Spa/tub Jet Interface

(71) Applicant: LMI ROTO, LLC, Lake Mary, FL (US)

(72) Inventor: Gary Harder, Lake Mary, FL (US)

(73) Assignee: LMI ROTO, LLC, LAKE MARY, FL (US)

(21) Appl. No.: 13/650,577

(22) Filed: Oct. 12, 2012

(51) Int. Cl. B32B 38/04

(52) U.S. Cl. 156/253

(57) ABSTRACT

A method and apparatus for forming a tubular orifice formed/added to a wall of a molded product such as a tub, spa, hot tub, boat hull, tank, vat, trough, etc. The resulting tubular orifice has a smooth, regular, tubular inner wall that seals well with accessories that have tubular interface sections that fit within the tubular orifice and seal using one or more o-rings. The orifice is formed around an insert that is removably held to an inside wall of a mold by, for example, magnets during rotational molding, thereby enabling extraction of the molded product from the mold as the inserts separate from the inside wall as the molded product is extracted.

This application is related to U.S. design patent application titled Spa Jet Design, attorney docket number 2699.13, filed evendate herewithin. This application is also related to U.S. patent application titled Spa Jet Interface, attorney docket number 2699.10, filed evendate herewithin. This application is also related to U.S. patent application titled Improved Spa Jet, attorney docket number 2699.12, filed evendate herewithin. This application is also related to U.S. patent application titled Improved Spa Filter Bypass, attorney docket number 2699.14, filed evendate herewithin.

### FIELD

This invention relates to the field of molded products and more particularly to a system and method for molding interface openings to molded products.

### BACKGROUND

There exist many ways to mold products from materials such as plastic, fiberglass and the like. Often, after molding, accessories are added to the molded product. For example, where the product is a spa, swim spa, pool, or bathtub, often accessories such as jets, drains, spigots, and faucets/controls are added after the molding/forming process is complete. Many such molded products require seals so that the area around these accessories do not leak. In the example given, a water-tight seal is desired, though in other examples, other requirements on such a seal may include being air-tight or resistant to leaking of various other liquids and/or gases and/or particulate material.

In the past, a simple hole is drilled into a wall of the molded product through which the accessory is inserted. For example, after a spa shell is molded, an appropriate sized drill bit is used to make holes in the wall for spa jets, etc. There are several issues with such a method of mounting the accessory when air or water leaks are to be avoided. The first issue is, with many molding processes (e.g. spin/rotational molding, spray molding, etc.), it is almost impossible to control the contour and thickness of the walls of the product. The side of the wall that abuts the mold is often flat and smooth, but the side of the wall from which the material is added/deposited (e.g. plastic, fiberglass, etc.) is not smooth and the walls are not of a consistent, predictable thickness. Many attempts have been made to utilize a gasket or caulking on one or both surfaces of the wall, around the accessory, requiring the face and back of the accessory to exert pressure against the gasket to prevent/reduce leaking. In many applications of such gaskets, heat/cool cycles expand/contract the sides at different rates than the expansion/contraction rate of the accessories; often causing leaks months or years after the accessory is installed at the factory. When caulking is used, the heat/cool cycles often cause the caulk to crack.

Since it is difficult to control the wall thickness, some manufacturers have resorted to grinding the back wall until it is smoother to improve upon the seal in the above molded/drilled wall. It is intended that the resulting wall has a certain thickness around the opening. This is but a marginal improvement being that the operator holding the grinder/sander only approximates the proper thickness and due to human inaccuracies, uniform thickness is rarely achieved.

After installation of a system such as a spa, after a leak begins, it is often difficult to repair. The back of the accessories (e.g. spa jets) are often inaccessible (e.g. when installed in the wall of a spa, tub) or, at least, difficult to reach, making it very difficult to tighten the accessory to increase the pressure on the gaskets and difficult to remove and replace the accessory should a new gasket or replacement caulk be needed.

In addition to front/back gaskets, some systems use a shoulder gasket, in which part of the gasket material extends into the circumferential diameter of the opening through which the accessory is mounted (e.g., a cross section of this gasket has an L-shape). This technique is of marginal improvement for several reasons. First, it still suffers from the need of the accessory applying pressure on the gasket as did the previous techniques. Second, because of the methods available for fabricating the holes in the product walls and the materials used to make the product walls, it is difficult to create an opening that conforms to any significant thickness and diameter tolerances. For example, when a drill is used, even though the drill is of a known size, any non-perpendicular angle of the drill results in uneven diameter openings resulting in openings that are not completely circular. Additionally, the materials used to mold the product also lead to inadequate openings. For example, a gel-coat backed with sprayed-on fiberglass is difficult to drill. The gel-coat is brittle and during drilling, cracks or splinters. The fiberglass has uneven surfaces in all directions, so that after drilling, the circumference of the hole will likely be uneven. Furthermore, considerable pressure is required to install the accessory into the shoulder gaskets, especially since it is difficult to control the diameter and regularity of the opening in the molded product wall.

The lack of a good seal (e.g., air-tight or water-tight) that remains sealed for years under typical usage patterns is evident by the failures of such seals causing leaks in tubs, drains, holding tanks, spas, pools, etc. As an example, some manufacturing companies include a tool and instructions for tightening each spa jet periodically throughout the life of the spa. Every month or two, each spa jet must be tightened or, eventually, one or more of the jets will leak.

What is needed is a sealing system that will prevent leaks in tubs and containers without the need for periodic tightening.

### SUMMARY

In one embodiment, an accessory sealing system includes a tubular orifice formed/added to a wall of a molded product such as a tub, spa, hot tub, boat hull, tank, vat, trough, etc. The tubular orifice has a smooth, regular, tubular inner wall that seals well with accessories that have tubular interface sections, fitting within the tubular orifice and sealing using one or more o-rings.

The sealing system takes advantage of the substantially smooth (e.g. regular) inner surface of the tubular orifice formed or appended to the molded shell (e.g., a tub shell, spa shell, container shell, etc.). An accessory fits within the orifice and has one or more o-rings (e.g., a gasket in the shape of a torus made of an elastomer) interfaced between the accessory and the orifice, thereby sealing the orifice from leaks, particularly, though not limited, from leaks of a liquid/gas from one side of the shell/container to the other size. The o-rings enable a low-force insertion/removal of the accessory and the use of simple, low-pressure, connectors for holding the accessory in place.

In alternate embodiments, the disclosed system/method for preparing molded products has many other uses, including, but not limited to, adding indent features into the sides of the molded products.

In one embodiment, a method of forming an orifice in a wall of a molded product is disclosed including removably affixing an insert on an inside wall of a mold then applying a structural material to the mold, forming the molded product. The structural material is allowed to set (e.g. cool, harden, solidify, etc.) then the molded product is separated from the mold, whereas the insert separates from the mold by way of the insert being removably affixed (to the mold). Now, any part of the insert remaining in the molded product is/are removed from (or fall out of) the molded product.

In another embodiment, a method of forming an orifice in a wall of a molded product (a spa shell) is disclosed including removably affixing a plurality of inserts on an inside wall of a mold, the mold being in the form of at least a portion of the spa shell then applying a structural material (e.g. plastic, resin, fiberglass) to the mold, forming the molded product. Next, the structural material is allowed to set then the molded product is separated from the mold, whereas the plurality of inserts separate from the mold by way of the inserts being removably affixed to the inside wall of the mold. The plurality of inserts is then removed from the molded product.

In another embodiment, a method of forming an orifice in a wall of a molded product during rotational molding is disclosed. The molded product is a spa shell. The method includes affixing a plurality of inserts on an inside surface of a wall of a rotational mold that is in the form of at least a portion of a spa shell. Each of the inserts is held to the inside wall of the rotational mold by an apparatus including a magnet and a bracket such that the bracket positions and holds the magnets in place on/through the inside surface of the wall of the rotational mold. An end of each of the inserts that abuts the inside surface of the wall has a higher thermally conductive disk and a distal end of each of the inserts has a lower thermally conductive disk. The higher thermally conductive disk shares an axis with the lower thermally conductive disk. A structural material (e.g. plastic, resin, etc.) is added to the rotational mold and the rotational mold is closed. The rotational mold in rotated in two directions while being heated, thereby the structural material melts and forms onto the inside surface of the rotational mold and onto the higher thermally conductive disk of each of the inserts. After the structural material to sets (e.g. cooling, solidification), the rotational mold is opened and the spa shell is separated from the rotational mold, whereas the plurality of inserts separate from the rotational mold by way of a shearing of the magnetic force holding each insert to the inner wall. Now, each of the plurality of inserts are removed from the spa shell.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a cross-sectional view of an exemplary mold and exemplary orifice forming system.

FIG. 2 illustrates a detailed cross-sectional view of a section of a mold, formed tub/spa wall, and a detailed cross-sectional view of an exemplary orifice forming system.

FIG. 3 illustrates an exploded view of the exemplary orifice forming system.

FIG. 4 illustrates a cross sectional view of an exemplary accessory fitting into an orifice in a tub/spa wall.

FIG. 5 illustrates a second exemplary system for creating an orifice in a spa/tub wall.

FIG. 6 illustrates the second exemplary system for creating an orifice in a spa/tub wall after application of a structural layer.

FIG. 7 illustrates the second exemplary system for creating an orifice in a spa/tub wall after application of a structural layer and showing installation of an exemplary accessory.

FIG. 8 illustrates an exploded view of an exemplary accessory for installation in a formed orifice.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Although the examples shown are closely related to installations of jets in a spa or tub, these are but examples, and many applications of the disclosed seal are anticipated. A non-limiting list of examples of installation targets includes boat hulls, pools, bath tubs, containers, bins, vats, tubs, troughs, etc. Any item that is molded and into which an accessory is added is anticipated, especially those in which the interface between the molded item and accessory needs to be water/gas tight is a candidate for the disclosed method of creating the orifice and/or the described seal and their equivalents.

Although the figures and description use a jet (e.g. spa jet) as an example of an accessory that is installed into an orifice formed in a wall of a molded product (e.g., tub or spa wall), there is no limitation on the use of the disclosed seal and any accessory to a molded product is anticipated, including, but not limited to, pipe connections, faucets, spigots, drains, filling tubes, door assemblies, valves, caps, sensor assemblies, or anything accessory that is added to a molded device.

The method of forming spa jet interface is described with respect to several methods of molding such products. Several examples of molding/forming methods are described in minimal details for context reasons and the details and accuracy of the exact molding/forming processes are not completely discloses for clarity and brevity reasons. There are many optional steps and variances of methods of making a molded product that vary from the examples shown and the method of forming spa jet interface is anticipated for any such variation.

The system, method, and apparatus for providing an interface between a molded product and an accessory include modifications/additions to the molded product and o-ring seals on the accessory. In the examples shown, the molded product is produced having a tubular orifice in which the accessory fits such that the o-ring seals provide a fluid-tight seal between the accessory and the molded product, as will be shown. Note that although a tubular orifice is preferred mating with an accessory having a circular diameter and having one or more o-rings about the circular diameter, there is no shape limitation. For example, in some embodiments, the shape of the orifice is that of an oval cross-section (e.g. an oval tube) and the o-ring conforms to the oval shape of the portion of the accessory that interfaces with the oval-cross section of the orifice. Any geometric cross-sectional shape is anticipated, and specialized o-rings are anticipated for use with cross-sectional shapes that have sharp edges (e.g. a triangular or square cross-sectional shape will work better using a triangular or square shaped o-ring).

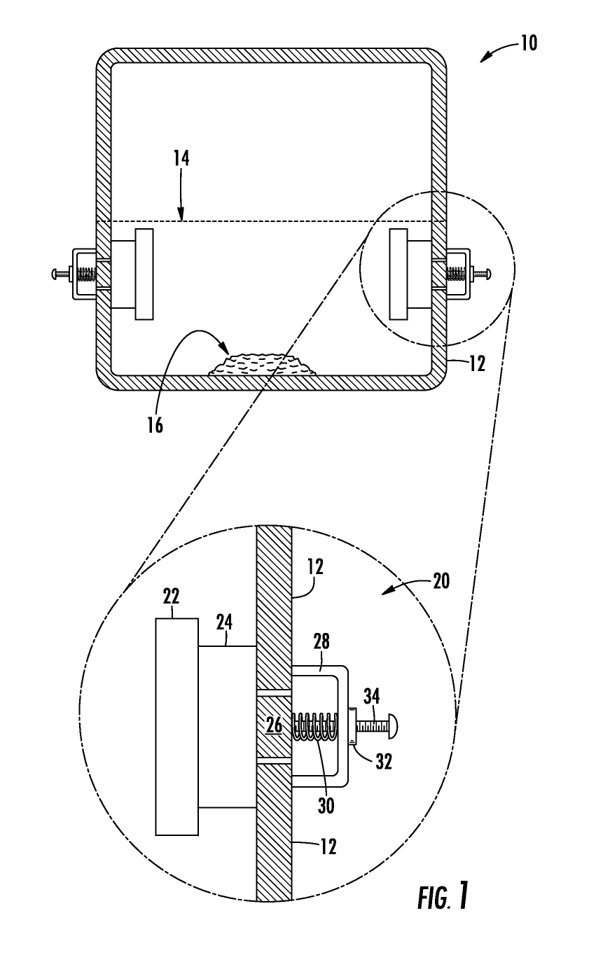

Referring to FIG. 1, a cross-sectional view of an exemplary mold 10 and exemplary orifice forming system 20 is shown. In this example, a mold 10 for a spa or tub is shown, though it is anticipated that the orifice forming system 20 be used with any type or shape of mold 10 for any type of device including, but not limited to a spa, hot tub, bin, vat, tub, trough, pipe, holding tank, pool, etc. In this example, the mold 10 is a rotational mold (e.g. Roto Mold). A rotational mold is, for example, a substantially hollow mold 10 that is filled with a charge or shot of material 16, and then the mold 10 is heated while it is rotated around two axis causing the charge or shot of material 16 to spread and stick to the heated walls of the mold 10. Therefore, any part of the mold system (mold 10 and orifice forming system 20) that is made of, for example, metal, absorbs enough heat to melt and accumulate portions of the material 16.

The mold 10 is rotated during the heating phase to avoid sagging or deformation and to deposit the material 16 as evenly as desired. After the charge or shot of material 16 has sufficiently melted and has been deposited substantially evenly across the inner walls of the mold 10, the mold is cooled (e.g. air cooled, water cooled, etc.). The mold 10 is also preferably rotated during the cooling to prevent sagging of the melted material 16 (typically a plastic material 16). Once the mold 10 and material 16 (now deposited on the inner walls of the mold 10) have cooled sufficiently to assure substantial solidification of the molded product (not shown in FIG. 1), the mold 10 is disassembled (e.g. along break line 14) and the molded product (not shown in FIG. 1) is pulled out of the mold 10.

Since the molded product needs to be pulled out of the mold 10, rotational molding works best with certain shapes that lend themselves to be pulled out of such a mold 10, such as substantially rectangular or rounded shapes as found in hot tubs, spas, bath tubs, holding takes, etc. Also, in the past, openings and inwardly pointing features were not molded into the side walls of the molded product because extensions of the mold 10 extending outwardly or inwardly in the mold 10 will inhibit removal of the molded product from the mold 10. For example, if an inwardly facing disk was needed to be formed in a side wall of the molded product, an inwardly facing protrusion is needed in the mold 10. After rotational molding, then cooling of the molded product, it is impossible or very difficult to pull the molded product out of the mold 10 unless the mold 10 disassembles into many more pieces than two (as shown the mold 10 disassembles at one break line 14).

There exists a need for certain features to be molded into the walls of a molded product. In the examples shown, it is advantageous to mold multiple tubular orifices into the sides of the molded product, each having a depth greater than the thickness of the molded product. If the side walls 12 of the mold 10 are created with these features, it would be very difficult or impossible to remove the molded product from the mold 10 after cooling because these features would impede removal of the molded product from the mold.

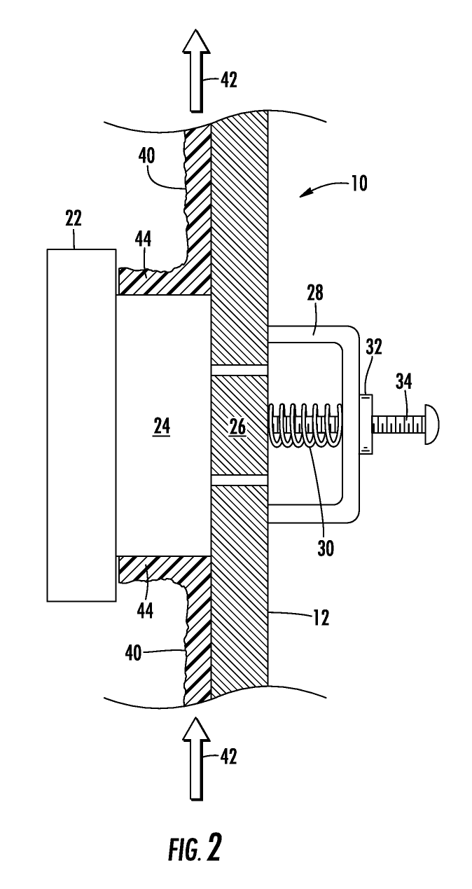

The orifice forming system 20 provides such features while enabling removal of the molded product from the mold 10. Although shown as an orifice 44 (see FIG. 2) having a depth deeper than the width of the molded product walls 40 (see FIG. 2), versions of the forming system 20 are anticipated for any need of a formed feature 44 in a sidewall 40 of a molded product, especially a rotationally molded product. The forming system 20 includes an insert 22/24 that is held to the wall 12 of the mold 10 by a magnet 26. The magnet 26 is retained against/through the wall 12 of the mold 10 by, for example, a bracket 28, screw 34, locking nut 32 and spring 30, though any mechanism that will hold the magnet 26 in place is equally anticipated. The mold insert 22/24 is made of any combination of higher thermally conductive parts 24 and lower thermally conductive parts 22. As the mold 10 is heated during the rotational molding process, the higher thermally conductive parts 24 heat sufficiently such that the charge or shot of material 16 sticks/melts to/on/over the higher thermally conductive parts 24, forming a shape that substantially matches the exposed area of the higher thermally conductive parts 24. At the same time, as the mold 10 is heated during the rotational molding process, the lower thermally conductive parts 22 do not heat enough to melt the charge or shot of material 16 and the material 16 does not substantially stick to the lower thermally conductive parts 22. In the example shown, the insert 22/24 has a disk of higher thermally conductive material 24 such as aluminum around which the material 16 melts and adheres and has a larger disk of lower thermally conductive material 22 such as polytetrafluoroethylene (Teflon) or nylon around which the material 16 does not stick.

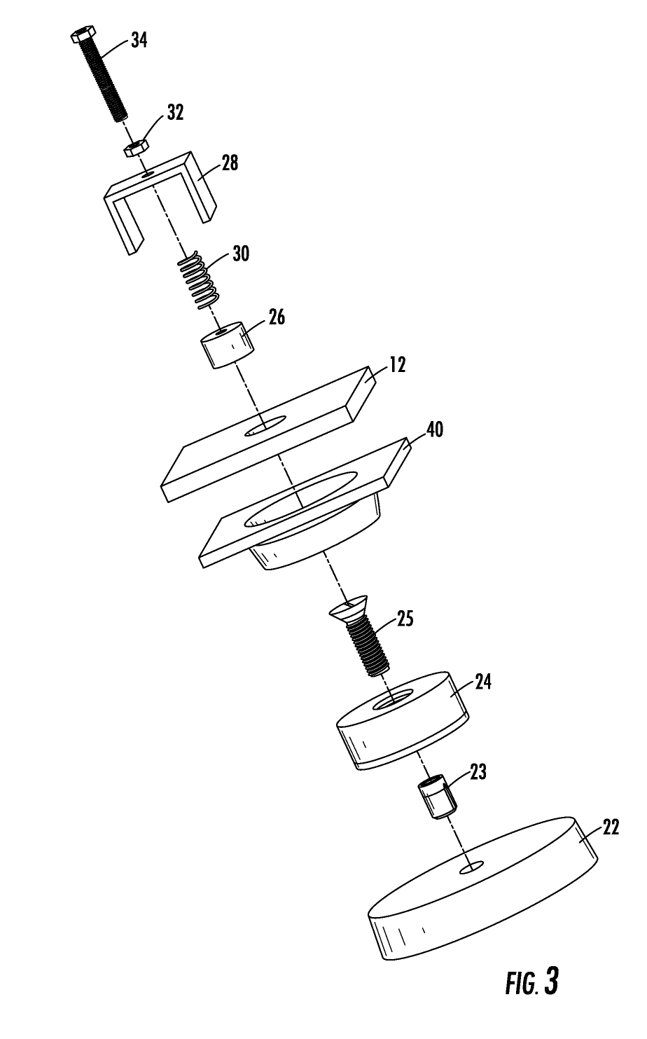

Some higher thermally conductive parts 24 are not magnetically attracted to the magnet 26 (e.g. when they are made of aluminum). For such, a magnetically attracted material is embedded on/within the higher thermally conductive parts 24. In this example, the lower thermally conductive parts 22 is held to the higher thermally conductive parts 24 by a bolt 25 (see FIG. 3) and bushing 23, of which at least the bolt 25 is made from a magnetically attracted material such as, but not limited to, iron or steel. In some embodiments, the bushing 23 is a collapsible bushing 23 that is press-fit into the lower thermally conductive part 22, then as the bolt 25 threads into the collapsible bushing 23, the collapsible bushing 23 expands to provide a tighter grip on the lower thermally conductive part 22.

Although the insert 22/24 is shown made of one higher thermally conductive disk-shaped part 24 and one lower thermally conductive disk-shaped part 22 to create a tubular opening 44 (see FIG. 2) in the wall 40 (see FIG. 2) of the molded product; any shape is anticipated depending on the desired shape of the feature. Since the lower thermally conductive part 22 (e.g., thermally insulative material) does not significantly collect the material 16 during the molding process, the shape of the lower thermally conductive part 22 does not affect the resulting feature in the molded product except as to control the edge of any desired openings (e.g. has sufficient overhang and completely covers the area of the higher thermally conductive part 24 where the opening is desired). For example, in an embodiment in which the lower thermally conductive part 22 is absent, both the outer planar surface and tubular walls of the conductive part 24 (disk) get covered by the material 16 and a disk-shaped dent is formed in the molded product instead of a tubular opening. In embodiments in which the insert 22/24 has no lower thermally conductive part(s) 22 (e.g. parts that will prevent/reduce buildup of material 16 around that part) the resulting molded product will not have an opening (e.g. will form an indentation, etc.).

Referring to FIG. 2, a detailed cross-sectional view of a section of a mold 10, formed tub/spa wall 40, and a detailed cross-sectional view of an exemplary orifice forming system 20 is shown after the material 16 has melted and formed around the inside of the mold 10 and the form 24. Note that no substantial amount of the material 16 has been deposited on the lower thermally conductive parts 22 because, during heating, the lower thermally conductive parts 22 did not heat to a temperature required to melt and attract/hold the material 16. Although it is anticipated that the lower thermally conductive parts 22 be made of any suitable material(s), certain materials such as polytetrafluoroethylene (Teflon) or nylon work better due to having a smooth surface, especially when polished, thereby attracting less of the material 16. It is preferred to make the lower thermally conductive parts 22 from a material or materials that will not melt during the heating/rotating portion of the process. Many materials are anticipated for the fabrication of the lower thermally conductive parts 22 as well as composite materials (e.g. a core that are coated), solid or hollow. There is no limitation to the material used to fabricate the lower thermally conductive parts 22 as long as a limited amount of material 16 buildup occurs on the lower thermally conductive parts 22 during the heating/rotating cycle.

In the molding example shown, the higher thermally conductive part 24 has a smooth, cylindrical outer surface (see FIG. 3). Therefore, the inner surface of the resulting orifice 44 will also be smooth and have substantially the same diameter, making the inner surface of the orifice 44 suitable for use with an o-ring seal, as will be shown. Because, in this example, the lower thermally conductive part 22 caps the entire outer surface of the higher thermally conductive part 24, no material 16 is deposited on that surface of the higher thermally conductive part 22, and, therefore, that end of the feature is left open after the molding process.

Once the molded product (e.g. tub shell, spa shell, pool shell, etc.) has cooled sufficiently to be removed from the mold 10, the mold 10 is disassembled (e.g. clamps holding portions of the mold 10 together along split line 14 during the molding process are removed), and the molded product 40/44 is pulled out of the mold 10 (e.g. in the direction of arrow 42). As the molded product releases from the walls of the mold 10, the magnet 26 also releases from the higher thermally conductive parts 24, as it is known that the force required to sheer a magnetic field is less than the force required to pull two magnetically attracted objects apart. In this exemplary form 22/24, the higher thermally conductive part 24 and one lower thermally conductive part 22 slide out of the mold 10 along with the molded part 40/44 and the retainer 30/32/34/28 and the magnet 26 remains with the mold 10 (or falls off).

Once the molded part 40/44 is removed from the mold 10, the higher thermally conductive part 24 and the lower thermally conductive parts 22 are removed from the molded part 40/44. In some cases, the parts 22/24 need to be “tapped” out of the molded product 40/44. Note—only a portion of the exemplary molded product 40/44 is shown for clarity purposes.

Referring to FIG. 3, an exploded view of the exemplary orifice forming system 20 is shown (after molding). Again, the exemplary insert 22/24 is of the shape of disks 22/24 for the purpose of creating one specific tubular orifice feature in the sidewall 40 of a molded product (e.g. spa shell) and any shape and combination of various shaped insert components 22/24 are anticipated for creating other shaped additions to a molded product.

The insert 22/24 of the forming system 20 is held to the wall 12 of the mold 10 by a magnet 26 which is retained against or within the wall 12 of the mold 10 by a bracket 28, screw 34, locking nut 32 and spring 30. This is an example and any mechanism that will hold the magnet 26 in place is equally anticipated. The insert 22/24 is made of any combination of higher thermally conductive parts 24 and lower thermally conductive parts 22. In one example, the higher thermally conductive part 24 is made of aluminum (or the same material that comprises the mold 10) and the lower thermally conductive part 22 is made of polytetrafluoroethylene (Teflon) or nylon.

A portion of the molded spa shell 40 is shown (after molding is complete). The planar surface of the spa shell that is visible is the surface that is visible by the user (e.g. water side). Note that the orifice as produced by the smooth, disk-shaped higher thermally conductive part 24 is tubular with smooth inner walls that mate well with an accessory that has one or more o-ring seals, as will be shown.

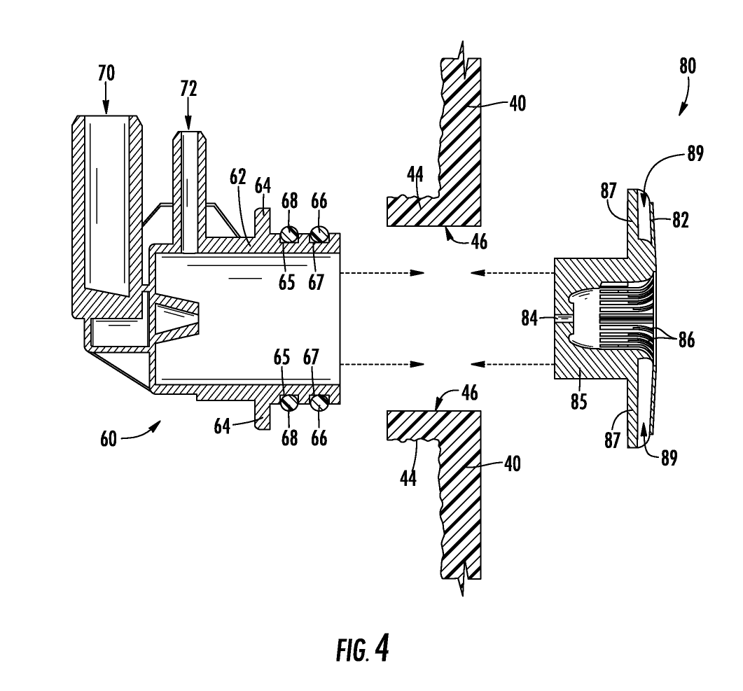

Referring to FIG. 4, a cross sectional view of an exemplary accessory 60/80 fitting into a tubular orifice 46 in a tub/spa wall 40 is shown. O-rings 66/68 are very good seals as used in many water systems such as faucets and drains. In the past, flat washers, shoulder washers, or caulking was used to seal accessories such as spa jets in orifices/holes in walls such as spa walls. As discussed above, such seals have known issues.

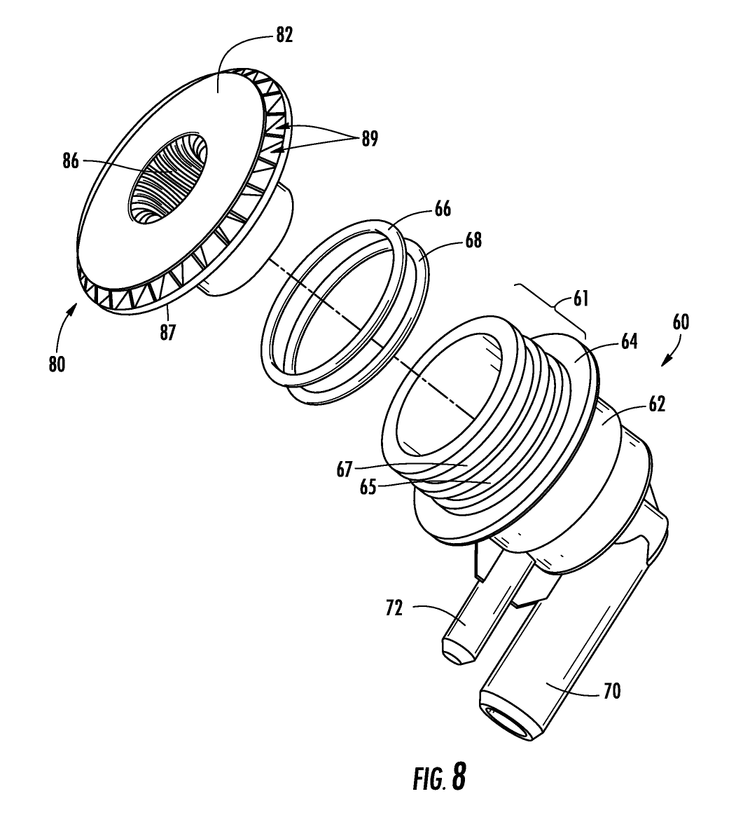

The accessory interface shown has a superior seal and requires no pressure from the spa jet or feature 80 against the spa jet body or base 60 to retain this seal because the o-rings 66/68 seal between o-ring grooves 65/67 and the inner wall 46 of the formed tubular orifice 44. Preferably, there is a retainment mechanism (e.g. a snap, wedge, press-fit, screw, snap, etc.) that retains the spa jet face 80 against/coupled—to the spa jet body 60. The base or body 60 has an interface area 61 (see FIG. 8) which has a cross-sectional shape that is substantially the same as a cross-sectional shape of the orifice 46 (circular cross-sectional shape in this example) and has a cross-sectional dimensions of the interface area 61 is substantially the same as a cross-sectional dimension of the orifice 46, thereby the interface area 61 of the base 60 fits into the orifice 46. This fit ranges from a relatively tight fit, perhaps requiring some amount of force to insert the interface area 61 into the orifice 46 or a loose fit which requires very little force to insert the interface area 61 into the orifice 46 until at least one o-ring or closed-loop elastomer seal 66/68 is installed in the at least one o-ring seat 65/67 (or closed-loop elastomer seal seat 65/67). A snug fit is preferred so that the o-ring or closed-loop elastomer seal 66/68 properly seals. In some embodiments, the orifice 46 is chamfered or has a slightly greater diameter at the insertion end to facilitate insertion of the interface area 61 without dislodging or slicing of the o-ring or closed-loop elastomer seal 66/68.

Although the accessory base 60 is shown as a typical spa jet base 60, any base is anticipated, including, but not limited to, valve bases, control bases, conduit bases, drain bases, filler bases, etc. Likewise, although the feature 80 is shown as a typical spa jet face 80, any feature 80 is anticipated, including, but not limited to, valve handles, control knobs, control buttons, faucets, drain covers, strainers, caps, etc.

Although many different accessories are anticipated for installation into many different molded products, the example shown is a jet or spa jet 60/80 installed into a formed tubular orifice 44/46 in a tub or spa wall 40. In this example, the spa jet body 62 has a substantially tubular insertion area 61 having at least one o-ring seat 65/67 (two are shown). The inner diameter of the tubular insertion area is close to, but preferably less than the diameter of the formed opening 46, allowing free insertion of the tubular insertion area into the formed opening 46 (before addition of o-rings 66/68). The tubular insertion area as shown in this example has an edge 64 that, as it is inserted into the formed opening 46, abuts the lip of the formed opening 46 and prevents over insertion, keeping the end of the tubular insertion area 61 from extending beyond the water side of the wall 40. For completeness, the typical water inlet 70 and air inlet 72 are shown.

After the o-rings 66/68 are seated into the at least one o-ring seats 65/67, the tubular insertion area is pushed into the formed opening 46 until the edge 64 abuts against the wall 44 of the formed opening 46. The o-rings 66/68 compress and apply a sealing force between the o-ring seats 65/67 and the smooth wall of the formed opening 46. Now the base 85 of the spa jet face 80 is inserted into the tubular insertion area and locked in place by any retainment mechanism known. As shown, the base 85 of the jet face 80 press fits into the tubular insertion area of the jet body 60. Although any type or style of jet face 80 is anticipated, the jet face 80 shown is a self-adjusting jet. The high-pressure flow of water/air passes through a fluid channel 84 towards an exit orifice 86 in the jet face 82. Towards the spa jet face 82, the fluid channel 84 optionally increases in diameter towards the exit orifice 86, providing an expansion of the outward flow. The fluid channel 84 is fluidly interfaced at angles (e.g. right angles) to a plurality of side exits 89, for example, between the face 82 and the inside wall 87 of the spa jet 80. Normally, as fluid flows through the fluid exit orifice 86, little fluid escapes through the side exits 89, but when the fluid exit orifice 86 is blocked or partially blocked, fluid escapes through the side exits 89, thereby eliminating the need to adjust the jets 60/80, making the jets 60/80 “self-adjusting” to accommodate a user laying against the jet 80. Again, the sealing system is useful with any type of jet or any other accessory including, but not limited to, drains, controls, faucets, filling tubes, faucets, sensors, etc.

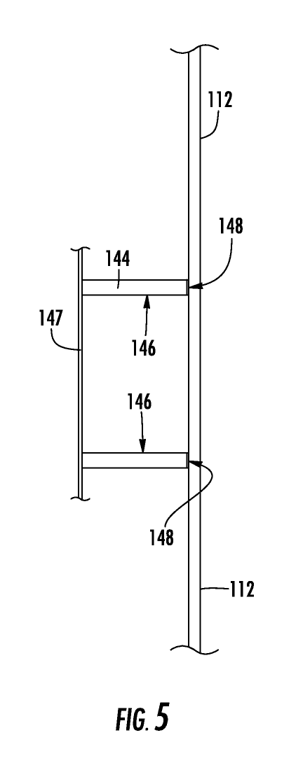

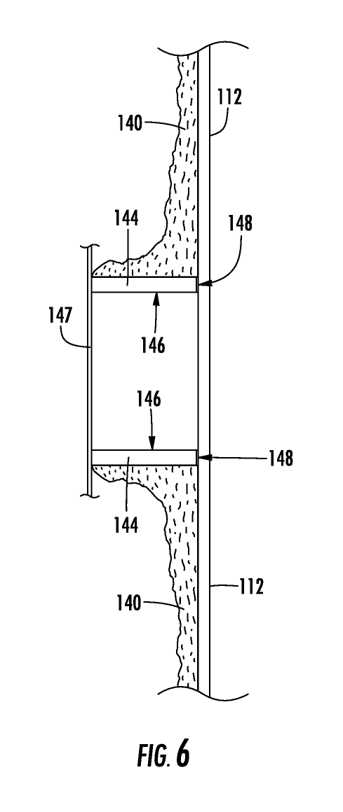

Referring to FIGS. 5 and 6, a second exemplary system for creating an orifice 146 in a spa/tub wall 112 is shown. The above molding system will not work for a spray-on molding method or vacuum formed molding method. Spray-on molding systems us a form known as a plug or buck (not shown). Typically, the plug is first sprayed with a release agent to help facilitate removal of the plug from the molded product. Next, the plug is coated with a gel coat (sprayed on, rolled on, brushed on, etc.). The gel coat provides a pigmented, smooth and durable surface. Next, a fiberglass coating is applied, either by affixing a fiberglass mat or spraying a layer of fiberglass over the gel coat. Once the fiberglass sets (hardens), the molded product (gel coat and fiberglass) are removed from the buck.

Products made by this and similar methods have very smooth inside surfaces (gel coat side), but orifices need be drilled after fabrication, having the inadequacies previously stated due to uneven drilling, human accuracy tolerances, material splintering, etc. Furthermore, it is difficult to polish the fiberglass material to make it smooth, due to the mixture of resins and glass within the material and it is difficult to spray/lay on an even layer of fiberglass. Because of these and other issues, it is difficult to make a round hole (orifice), around which the wall has a constant, predictable thickness. Therefore, prior methods using gaskets, shoulder gaskets, and/or caulking provide weak seals that often fail or require tightening.

There are several ways to fabricate the desired tubular orifice into molded products that are produced using such spray-on or vacuum molding processes. The above described steps work well with spray-on molds, whereas, the orifice forming system 20 is removably held to the mold wall 12 (not shown in FIGS. 5 and 6) by, for example, magnetic forces (as previously described) before the gel coat 112 is applied. The orifice forming system 20 remains removably affixed to the mold wall 12 during the application of the gel coat layer 112 and the structural layer 140, forming the desired shaped feature, open (as shown) or closed (not shown). After the gel coat 112 and structural layer 140 set, the molded product is removed from the mold 10 and the orifice forming system 20 is removed from the molded product.

Alternately, for many types of molding processes, including spray-on and vacuum molding, the o-ring sealing system as described above is integrated into molded products using add-on molding techniques. A cylindrical tube 144 is inserted during the molding process, after the gel coat 112 is applied to the buck (not shown). The cylindrical tube is any tube of any material suitable for such installation including, but not limited to, a section of PVC pipe, a section of copper pipe, any metal or plastic pipe, etc. After the gel coat 112 is applied to the buck (not shown), the cylindrical tube 144 is affixed at the desired location, preferably by an adhesive 148 (permanent or temporary) or any other known way of holding the cylindrical tube 144 to the gel coat 112. In one embodiment, the cylindrical tube 144 is pressed onto the gel coat 112 during the setting cycle, while the gel coat 112 is still tacky.

The open end of the cylindrical tube 144 is covered with a cover 147 made of any suitable material. Although hard covers such as corks and plugs will work, a simple coating of tape such as duct tape works well. It is preferred, though not required, that the cover 147 is trimmed so that it does not extend beyond the outer circumference of the cylindrical tube 144.

Once the gel coat 112 is ready (e.g., set or partially set), the cylindrical tube 144 is affixed to the gel coat 112 at the desired location. The end of the cylindrical tube 144 is covered with a cover 147 before or after affixing the cylindrical tube 144 to the gel coat 112.

As shown in FIG. 6, the structural layer 140 (e.g.

fiberglass) is applied over the gel coat 112 and over the outer surface of the cylindrical tube 144, forming the inner, structural layer 140 of the molded product 140. As discussed, there are many ways to apply the structural coat 140 of any known material such as fiberglass, including affixing sheets or mats of material (e.g. fiberglass) and spraying resins, fiberglass, etc., over the gel coat 112 and cylindrical tube 144. Note that with spraying, some of the material will overspray the cover 147, but the cover 147 will prevent the material (e.g. fiberglass, resins, etc.) from contaminating the smooth, cylindrical inner surface 146 of the cylindrical tube 144.

Once the structural coat 140 sets (e.g. hardens), the cover 147 is removed. In some embodiments in which the cover 147 is coated with the structural material, a tool is required to remove the cover 147.

Before or after the cover 147 is removed, the gel coat 112 that covers the other end of the cylindrical tube 144 is removed. In many applications, the accessory that is installed into the orifice formed by the cylindrical tube 144 has a face that covers beyond the perimeter of the cylindrical tube 144, so minor chipping and uneven edges of the gel coat 112 where it meets the cylindrical tube 144 are acceptable. In some embodiments, a tool such as a reamer, a drill, a hole punch, etc., is used to remove the gel coat 112 around the cylindrical tube 144.

There are many ways to add an orifice to a molded product, the above being examples of such. Again, the shape of the orifice 46/146 has been described as tubular, though any cross-section is anticipated to match the cross-section of the base 62 of the accessory 60/80, such as an oval cross-section, square cross-section, etc.

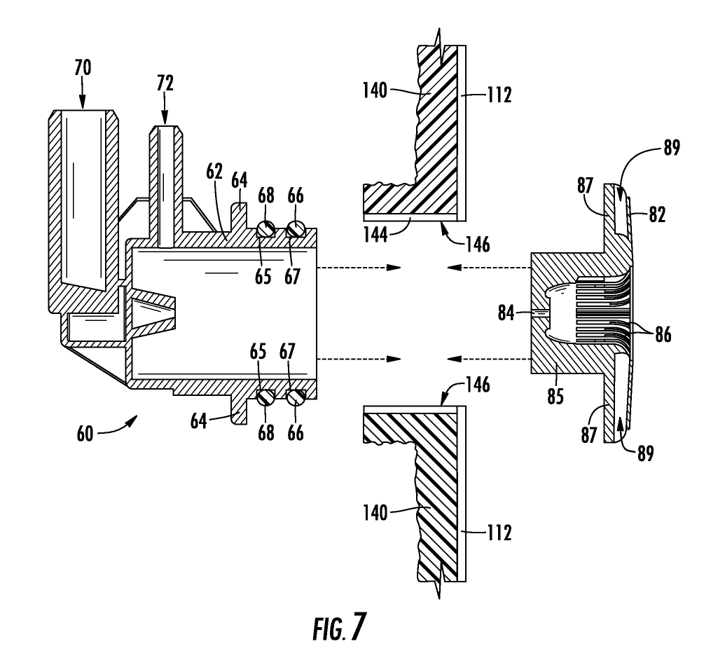

Referring to FIG. 7, the molded product wall made using the second exemplary system for creating an orifice in a wall is shown related to the installation of an exemplary accessory. In this example, the same jet 60 and jet face 80 is shown for installation into a spa/tub wall 112/140.

In this, the spa/tub wall 112/140 are made according to the second system/method, having a smooth gel coat wall 112 (that which contact the water and user) and a structural side 140 made of a structural material such as resins, fiberglass, etc. As previously described, the cylindrical tube 144 is installed hand held in place by the structural material and the cover 147 is removed, as well as the gel coat 112 around the face of the cylindrical tube 144.

As in the previous examples, many different accessories are anticipated for installation into many different molded products and the example shown is a jet or spa jet 60/80 installed into the cylindrical tube 144 of a tub or spa wall 140/112. In this example, the spa jet body 62 has a substantially tubular insertion area having at least one o-ring seat 65/67 (two are shown). The diameter of the tubular insertion area is close to, but less than the diameter of the inner surface 146 of the cylindrical tube 144, allowing free insertion of the tubular insertion area into the cylindrical tube 144 (before addition of o-rings 66/68). The tubular insertion area as shown has a ledge 64 that, as it is inserted into the formed opening 146, abuts the lip of the formed opening 146 and prevents over insertion, keeping the end of the tubular insertion area from extending beyond the end of the cylindrical tube 144. For completeness, the typical water inlet 70 and air inlet 72 are shown.

After one or more o-rings 66/68 are seated into the at least one o-ring seats 65/67, the tubular insertion area is pushed into the cylindrical tube 144 until the edge 64 abuts against the inner end of the cylindrical tube 144. The o-rings 66/68 compress and apply a sealing force between the o-ring seats 65/67 and the smooth wall 146 of the cylindrical tube 144. Now the base 85 of the jet face 80 is inserted into the tubular insertion area and locked in place by any retainment mechanism known. As shown, the base 85 of the jet face 80 press fits into the tubular insertion area of the jet body 60. Although any type or style of jet face 80 is anticipated, the jet face 80 shown is a self-adjusting jet. The high-pressure flow of water/air passes through a fluid channel 84 in the jet face 80. The fluid channel 84 is fluidly interfaced at angles (e.g. right angles) to a plurality of side exits 89 between the face 82 and the inner wall 87 of the jet 80. Normally, as fluid flows through the fluid channel 84, little fluid escapes through the side exits 89, but when the exit orifice 86 is blocked or partially blocked, some or all of the fluid exits through the side exits 89, thereby eliminating the need to adjust the jets, making these jets 80 “self-adjusting” to accommodate a user lying against the jet 80. Again, the sealing system is useful with any type of jet or any other accessory including, but not limited to, drains, controls, faucets, filling tubes, faucets, sensors, etc.

Referring to FIG. 8, an exploded view of an exemplary accessory is shown. In this view, the spa jet body 60 has a substantially tubular insertion area having at least one o-ring seat(s) 65/67 (two are shown). The tubular insertion area 61 as shown has an edge 64 that limits insertion, controlling the depth of insertion of the jet body 60 in the tub/spa tubular orifice 146. For completeness, the typical water inlet 70 and air inlet 72 are shown.

One or more o-rings 66/68 are seated into the at least one o-ring seats 65/67. The base 85 of the jet face 80 inserts into the tubular insertion area 61 and locks in place by any retainment mechanism known. In this example, the base 85 of the jet face 80 press fits into the tubular insertion area 61 of the jet body 60. Although any type or style of jet face 80 is anticipated, the jet face 80 shown is a self-adjusting jet. The high-pressure flow of water/air passes through a fluid channel 84 in the jet face 80. The fluid channel 84 is fluidly interfaced at angles (e.g. right angles) to a plurality of side exits 89 between the face 82 and the inner wall 87 of the jet 80. Normally, as fluid flows through the fluid channel 84, little fluid escapes through the side exits 89, but when the exit orifice 86 is blocked or partially blocked, some or all of the fluid escapes through the side exits 89, thereby eliminating the need to adjust the jets, making these jets 80 “self-adjusting” to accommodate a user lying against the jet 80. Again, the sealing system is useful with any type of jet or any other accessory including, but not limited to, drains, controls, faucets, filling tubes, faucets, sensors, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of forming an orifice in a wall of a molded product, the method comprising:
removably affixing an insert on an inside wall of a mold;
applying a structural material to the mold, forming the molded product;
allowing the structural material to set;
separating the molded product from the mold, whereas the insert separates from the mold by way of the insert being removably affixed; and
removing the insert from the molded product.

2. The method of claim 1, whereas the insert is removably affixed to the inside wall of the mold by magnetic force.

3. The method of claim 1, wherein the molded product is a spa.

4. The method of claim 1, wherein the molded product is a bath tub.

5. The method of claim 1, wherein the structural material is a resin and the step of applying the structural material to the mold includes heating the mold while rotating the mold.

6. The method of claim 5, wherein the insert has two parts, a first part having properties in which the structural material adheres to the first part and a second part in which the structural material does not substantially adhere to the second part.

7. The method of claim 6, wherein the first part has a higher level of heat conduction, thereby heating enough as to collect the material and the second part has a lower level of heat conduction, thereby not heating sufficiently as to collect substantial amounts of the material.

8. The method of claim 6, wherein the molded part is a tub/spa, the first part is a disk comprising a metal and having a first diameter, and the second part is a disk made of plastic and having a diameter that is greater than the first diameter.

9. The method of claim 8, wherein the metal is aluminum and the plastic is polytetrafluoroethylene (Teflon).

10. The method of claim 1, wherein the structural material is fiberglass and the step of applying the structural material to the mold further comprises:
applying a gel coat to the mold before the step of applying the structural material to the mold;
allowing the gel coat to at least partially set;
affixing a first end of one or more tubular objects to the gel coat;
covering an distal second end of each of the one or more tubular objects;
spraying the fiberglass over the gel coat and the one or more tubular objects.

11. A method of forming an orifice in a wall of a molded product, the molded product being a spa shell, the method comprising:
removably affixing a plurality of inserts on an inside wall of a mold, the mold being in the form of at least a portion of a spa shell;
applying a structural material to the mold, forming the molded product;
allowing the structural material to set;
separating the molded product from the mold, whereas the plurality of inserts separate from the mold by way of the inserts being removably affixed; and
removing the plurality of inserts from the molded product.

12. The method of claim 11, whereas each of the plurality of inserts is removably affixed to the inside wall of the mold by magnetic force.

13. The method of claim 11, wherein the structural material is a resin and the step of applying the structural material to the mold includes heating the mold while rotating the mold.

14. The method of claim 5, wherein the insert has two disk-shaped parts, a first disk-shaped part made from a first material having a higher level of heat conduction such that the structural material adheres to the first disk-shaped part during the heating and a second disk-shaped part made from a second material having a lower level of heat conduction such that the structural material adheres less to the second disk-shaped part during the heating.

15. The method of claim 14, wherein the first material is aluminum and the second material is polytetrafluoroethylene (Teflon).

16. A method of forming a plurality of orifices in a wall of a molded product during rotational molding, the molded product being a spa shell, the method comprising:
affixing a plurality of inserts on an inside surface of a wall of a rotational mold, the rotational mold being in the form of at least a portion of a spa shell, each of the plurality of inserts held to the inside wall of the rotational mold by an apparatus including a magnet and a bracket, the bracket positioning and holding the magnet in place on the wall of the rotational mold, an end of each of the inserts that abuts the inside surface of the wall having a higher thermally conductive disk and a distal end of each of the inserts having a lower thermally conductive disk;
adding a structural material to the rotational mold;
closing the rotational mold;
rotating the rotational mold in two directions while heating the rotational mold, thereby the structural material melts and forms onto the inside surface of the rotational mold and onto the higher thermally conductive disk of each of the inserts;
allowing the structural material to set;
opening the rotational mold;
separating the spa shell from the rotational mold, whereas the plurality of inserts separate from the rotational mold by way of a shearing of the magnetic force holding each insert to the inner wall; and
removing each of the plurality of inserts from the spa shell.

17. The method of claim 16, wherein the structural material is a resin.

18. The method of claim 16, wherein the higher thermally conductive disk is made from metal such that the structural material adheres to the higher thermally conductive disk during the heating and the lower thermally conductive disk is made from plastic such that the structural material adheres less to the lower thermally conductive disk during the heating.

19. The method of claim 18, wherein the metal is aluminum and the plastic is polytetrafluoroethylene (Teflon).

20. The method of claim 16, wherein the higher thermally conductive disk and the lower thermally conductive disk share a common axis, and a diameter of the higher thermally conductive disk is smaller than a diameter of the lower thermally conductive disk.
